(19) United States
(12) Patent Application Publication
(10) Pub. No.: US 2020/0221787 A1
(43) Pub. Date: Jul. 16, 2020

(54) POWER SUPPLY AND ELECTRONIC CIGARETTE HAVING SAME

(71) Applicant: Hong Kong IVPS International Limited, Central (HK)

(72) Inventor: Junwei OUYANG, Shenzhen (CN)

(73) Assignee: Hong Kong IVPS International Limited, Central (HK)

(21) Appl. No.: 16/594,735

(22) Filed: Oct. 7, 2019

(30) Foreign Application Priority Data
Sep. 12, 2018 (CN) 201821496018.5

(51) Int. Cl. A24F 47/00; H01M 2/10

(52) U.S. Cl. CPC A24F 47/008; H01M 2220/30; H01M 2/1055

(57) ABSTRACT

The invention discloses a power supply and an electronic cigarette having same. The power supply comprises a main body which comprises a mounting groove for accommodating an external battery. One end of the mounting groove is convexly provided with a first conductive contact and at least one supporting member, and a height at which the at least one supporting member protrudes is greater than a height at which the first conductive contact protrudes. The battery is provided with a contact head protruding from the body of the battery; when the battery is properly mounted in the mounting groove, the contact head is abutted against the first conductive contact establish an electrical connection; when the battery is reversely mounted in the mounting groove, the supporting member is abutted against the body of the battery so that the body of the battery is spaced apart from the first conductive contact.

### TECHNICAL FIELD

The invention relates to a power supply and an electronic cigarette having same.

### BACKGROUND

Electronic cigarettes, also known as electronic cigarettes, are mainly used to quit smoking and replace conventional cigarettes. It has an appearance and taste similar to conventional cigarettes, and even has more tastes than conventional cigarettes. It can generate smoke, a taste and a feel like conventional cigarettes. Since electronic cigarettes have no tar, suspension particles and other harmful components in conventional cigarettes, electronic cigarettes have gradually replaced conventional cigarettes in the market

In order to generate a high power to produce large smoke, electronic cigarettes in the market usually have a plurality of batteries therein to enhance the endurance of the electronic cigarette. However, when the battery of the electronic cigarette has a large capacity, a USB cable is used for charging, and the rate is slow. Then, the battery is disassembled and then charged by means of a desktop charger. After the battery is recharged, it is prone to the phenomenon that the direction is reversed to result in a short circuit so as to burn the circuit board or fire and explode when the battery is reassembled.

Therefore, the circuit board is usually provided with an anti-reverse connecting circuit for protection, which results in a complicated circuit board layout, thereby increasing the size of the circuit board, affecting the product volume, and increasing the manufacturing cost.

### SUMMARY

The main purpose of the invention is to provide a power supply for an electronic cigarette, which aims to adopt a physical mounting structure to avoid the occurrence of a short circuit caused by reverse connection of the battery and effectively save cost.

In order to achieve the above object, the invention provides a power supply for an electronic cigarette, comprising: a main body, wherein the main body comprises a mounting groove for accommodating an external battery, one end of the mounting groove is convexly provided with a first conductive contact and at least one supporting member, and a height at which the at least one supporting member protrudes is greater than a height at which the first conductive contact protrudes;

the battery is provided with a contact head protruding from the body of the battery, and when the battery is properly mounted in the mounting groove, the contact head is abutted against the first conductive contact to establish an electrical connection; and when the battery is reversely mounted in the mounting groove, the supporting member is abutted against the body of the battery so that the body of the battery is spaced apart from the first conductive contact.

Preferably, there are two supporting members, the two supporting members are symmetrically provided on both sides of the first conductive contact, a supporting space is formed between opposite surfaces of the two supporting members, when the battery is properly mounted in the mounting groove, the contact head is inserted into the supporting space to be abutted against the first conductive contact, and when the battery is reversely mounted in the mounting groove, the supporting member is abutted against the body of the battery.

Preferably, the thickness of the two supporting members gradually increases from the end adjacent to the notch of the mounting groove to the end away from the notch of the mounting groove so that the end of the two supporting members adjacent to the notch of the mounting groove forms a wedge-shaped guiding portion.

Preferably, the main body is further provided with a circuit board, the circuit board is provided with a socket corresponding to the first conductive contact, one end of the first conductive contact is inserted into the socket and is electrically connected to the circuit board, and the other end thereof is accommodated in the supporting space.

Preferably, the circuit board is further electrically connected to a second conductive contact, the accommodating chamber is provided with an avoidance hole corresponding to the second conductive contact, one end of the second conductive contact is elastically mounted in the main body and is electrically connected to the circuit board and the other end thereof is accommodated in the mounting groove through the avoidance hole and forms a mounting vacancy in which the battery is mounted with the first conductive contact, the second conductive contact is movable toward the inside of the main body along the avoidance hole under the action of an external extrusion force, and the battery is mounted in the mounting groove.

Preferably, the mounting groove is provided with at least two of the first conductive contacts and at least two of the second conductive contacts, at least two of the first conductive contacts and at least two of the second conductive contacts are correspondingly mounted in the mounting groove and are provided side by side at intervals to form at least two mounting vacancies provided side by side at intervals, and the intersection of each two mounting vacancies is hollowed-out to form an avoidance space.

Preferably, each of the avoidance spaces is provided with at least one separator, and at least one separator is provided between the two conductive contacts provided adjacent to each other to separate the batteries accommodated in the two adjacent mounting vacancies.

The invention further provides an electronic cigarette, comprising a power supply for an electronic cigarette, wherein the power supply for an electronic cigarette comprises a main body, the main body is provided with a first conductive contact and a mounting groove for accommodating an external battery, one end of the mounting groove is convexly provided with at least one supporting member, a supporting space is formed between an end surface of the protruding tail end of the at least one supporting member and a plane of the protruding head end; one end of the first conductive contact is mounted on the main body, and the other end thereof is accommodated in the supporting space; one end of the battery is provided with a contact piece flush with the end surface, and the other end thereof is provided with a contact head protruding from the end surface, when the battery is properly mounted in the mounting groove, the contact head extends into the supporting space to be abutted against the first conductive contact to establish an electrical connection; and when the battery is reversely mounted in the mounting groove, the supporting member is abutted against the end surface of the battery to block the contact piece outside the supporting space and disconnect the electrical connection.

The power supply for the electronic cigarette according to the technical solution of the invention is provided with a supporting member in the mounting groove in which the battery is mounted. A height at which the supporting member protrudes is greater than a height at which the first conductive contact protrudes. Therefore, a supporting space is formed between an end surface of the extending tail end of the supporting member and a surface of the head end, and the first conductive contact is accommodated in the supporting space. Therefore, when the battery is properly mounted in the mounting groove, the contact head of the battery protruding from the end face extends into the supporting space to establish an electrical connection with the first conductive contact to power the main body of the electronic cigarette. When the battery is reversely mounted, the supporting member is abutted against the end surface of the battery, so that the battery is blocked outside the supporting space and cannot establish an electrical connection with the first conductive contact normally. It effectively avoids the occurrence of a short circuit caused by reverse connection of the battery. At the same time, it is not necessary to provide a forward or reverse connecting circuit on the circuit board for protection, which effectively saves manufacturing cost. In addition, the wiring structure of the circuit board is relatively simple, and the wiring area of the circuit board is saved, so that the structure is more compact, thereby reducing the volume of the product, effectively enhancing the user experience.

### BRIEF DESCRIPTION OF THE DRAWINGS

For a better illustration of the embodiments of the invention or the technical solution in the prior art, accompanying drawings needed in the description of the embodiments or the prior art are simply illustrated below. Obviously, the accompanying drawings described below are some embodiments of the invention. For those skilled in the art, other accompanying drawings may be obtained according to the structure shown in these accompanying drawings without creative work.

FIG. 1 is a partial schematic diagram illustrating a connecting structure in which a battery is properly mounted in the mounting groove in a power supply for an electronic cigarette according to the invention;

FIG. 2 is a partially enlarged schematic diagram at A in FIG. 1 according to the invention;

FIG. 3 is a cross-sectional schematic diagram taken along line A-A of FIG. 1 according to the invention;

FIG. 4 is a schematic diagram illustrating a connecting structure in which a battery is reversely mounted in the mounting groove in a power supply for an electronic cigarette according to the invention;

FIG. 5 is a front schematic diagram illustrating a connecting structure in which a battery is not mounted in the mounting groove in a power supply for an electronic cigarette according to the invention;

FIG. 6 is a perspective schematic diagram illustrating a connecting structure in which a battery is not mounted in the mounting groove in a power supply for an electronic cigarette according to the invention;

FIG. 7 is a perspective schematic diagram illustrating a connecting structure of a battery in a power supply for an electronic cigarette according to the invention.

### DESCRIPTION OF THE REFERENCE NUMBERS

| Reference number | Name of part |
|---|---|
| 100 | Power supply |
| 10 | Main body |
| 11 | mounting groove |
| 111 | supporting member |
| 1111 | supporting space |
| 1112 | guiding portion |
| 1113 | Protruding tail end |
| 1114 | Protruding head end |
| 112 | avoidance space |
| 12 | first conductive contact |
| 13 | second conductive contact |
| 131 | mounting vacancy |
| 14 | circuit board |
| 141 | socket |
| 15 | separator |
| 200 | battery |
| 210 | contact head |
| 220 | Contact piece |

The implementation of aims, the function features and the advantages of the invention are described below in further detail in conjunction with embodiments with reference to the drawings.

### DESCRIPTION OF THE EMBODIMENTS

A clear and complete description as below is provided for the technical solution in the embodiments of the invention in conjunction with the drawings in the embodiments of the invention. Obviously, the embodiments described hereinafter are simply part embodiments of the invention, rather than all the embodiments. All other embodiments obtained by those skilled in the art based on the embodiments in the invention without creative work are intended to be included in the scope of protection of the invention.

It should be noted that all directional indications (such as top, bottom, left, right, front, behind . . . ) in the embodiments of the invention are merely to illustrate a relative position relation, a relative motion condition, etc. between each part in a certain state (for example, the state shown in the drawings). If the state changes, the directional indication changes accordingly.

In addition, if terms “first”, “second”, etc. appear in the invention, they are merely for the purpose of description, but cannot be understood as the indication or implication of relative importance or as the implicit indication of the number of the designated technical features; therefore, features defined by “first” and “second” may specifically or implicitly comprise at least one such feature. In addition, technical solutions of each embodiment of the invention may be combined mutually; however, this must be carried out on the basis that those skilled in the art can implement the combination. When the combination of technical solutions has a conflict or cannot be implemented, it should considered that such combination of technical solutions does not exist and is not in the scope of protection claimed by the invention.

In the invention, unless otherwise specifically stated and defined, terms “connected”, “fixed”, etc. should be interpreted expansively. For example, “fixed” may be fixed connection, detachable connection, or integration; may be mechanical connection or electrical connection; direct connection, indirect connection through an intermediate, or internal communication between two elements or interaction of two elements, unless otherwise specifically defined. Those skilled in the art can understand the specific implication of the above terms in the invention according to specific conditions.

The invention provides an electronic cigarette, which comprises an atomizing device (not shown) and a power supply 100 for supplying power to the atomizing device, wherein the atomizing device is provided with an accommodating chamber in which tobacco products are accommodated and a heating component for heating the tobacco products. When the atomizing device is mounted on the power supply 100, the power supply 100 supplies power to the heating component to heat the tobacco products stored in the atomizing device to generate smoke for the user to smoke. Herein, the tobacco products may be made of tobacco shred, tobacco tar, cigarettes, or tobacco cartridge prepared from tobacco shred etc. In the embodiment of the invention, the tobacco tar is selected as an example, and the atomizing device in which the tobacco tar is stored is externally connected to the power supply 100.

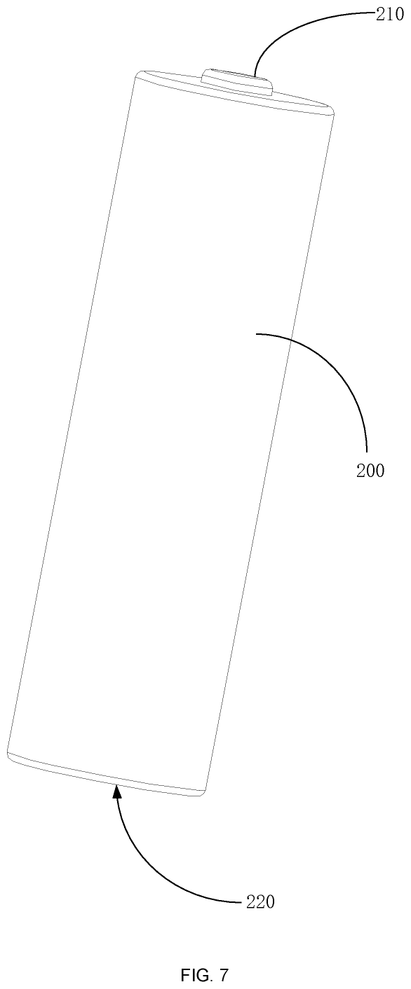

Referring to FIG. 1 to FIG. 7, the power supply 100 comprises a main body 10. The main body 10 comprises a mounting groove 11 for accommodating an external battery 200. One end of the mounting groove 11 is convexly provided with a first conductive contact 12 and at least one supporting member 111, and a height at which the at least one supporting member 111 protrudes is greater than a height at which the first conductive contact 12 protrudes;

one end of the battery 200 is provided with a contact piece 220 flush with the end surface, and the other end thereof is provided with a contact head 210 protruding from the end surface, when the battery 200 is properly mounted in the mounting groove 11, the contact head 210 is abutted against the first conductive contact 12 to establish an electrical connection; and when the battery 200 is reversely mounted in the mounting groove 11, the supporting member 111 is abutted against the body of the battery 200 so that the contact piece 220 provided on the body of the battery 200 is spaced apart from the first conductive contact 12, and an electrical connection cannot be established.

The power supply 100 for an electronic cigarette according to the technical solution of the invention is provided with a supporting member 111 in the mounting groove 11 in which the battery 200 is mounted. A height at which the supporting member 111 protrudes is greater than a height at which the first conductive contact 12 protrudes. Therefore, a supporting space 1111 is formed between an end surface of the extending tail end of the supporting member 111 and a surface of the head end, and the first conductive contact is accommodated in the supporting space 1111. Therefore, when the battery 200 is properly mounted in the mounting groove 11, the contact head 210 of the battery 200 protruding from the end face extends into the supporting space 1111 to establish an electrical connection with the first conductive contact to power the main body 10 of the electronic cigarette. When the battery 200 is reversely mounted, the supporting member 111 is abutted against the end surface of the battery 200, and the contact piece 220 is flush with the end surface of the battery 200, so that the battery is blocked outside the supporting space 1111 and cannot establish an electrical connection with the first conductive contact normally. It effectively avoids the occurrence of a short circuit caused by reverse connection of the battery 200. At the same time, it is not necessary to provide a forward or reverse connecting circuit on the circuit board 14 for protection, which effectively saves manufacturing cost. In addition, the wiring structure of the circuit board 14 is relatively simple, and the wiring area of the circuit board 14 is saved, so that the structure is more compact, thereby reducing the volume of the product, effectively enhancing the user experience.

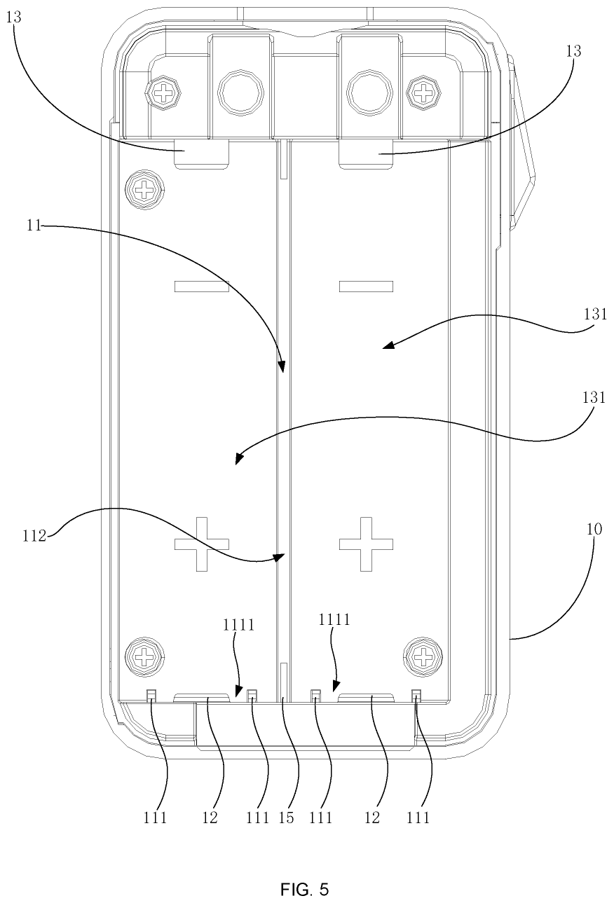

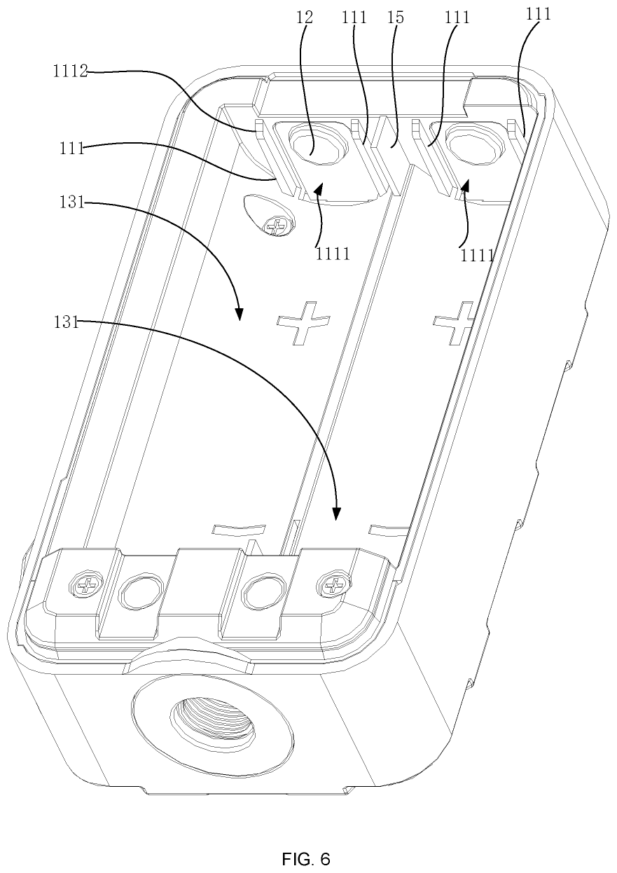

Specifically, as shown in FIG. 5 or FIG. 6, in the embodiment of the invention, there are two supporting members 111, the two supporting members 111 are symmetrically provided on both sides of the first conductive contact, a supporting space 1111 is formed between opposite surfaces of the two supporting members 111, and when the battery 200 is reversely mounted in the mounting groove 11, the two supporting members 111 are abutted against the end surface of the battery 200. Herein, in the present embodiment, the two supporting members 111 are symmetrically provided on both sides of the first conductive contact, so that when the battery 200 is mounted in the mounting groove 11, the two supporting members 111 are abutted against both sides of the end surface of the battery 200 so that the battery 200 has a more uniform stress, effectively preventing the battery 200 from being biased by the unilateral stress. At the same time, the distance between the two supporting members 111 forms an avoidance vacancy in which the contact head 210 swings when the battery 200 is mounted, preventing the phenomenon that the outer wall of the battery 200 is damaged and short-circuited.

It can be understood that, in the actual application process, it not limited to the manner in which two supporting members 111 symmetrically provided are provided in the above embodiment to balance the stress when the battery 200 is mounted in the mounting groove 11. For example, in another embodiment of the invention, the manner, in which three supporting members 111 may be provided, the three supporting members 111 are provided at equal intervals, or a half-ring supporting member 111 or the like is provided to balance the stress of the battery 200, falls within the scope of protection of the invention.

In the same way, it can be understood that, in the actual application process, it not limited to the manner in which a supporting space 1111 is formed on the supporting member 111. For example, in another embodiment of the invention, the manner, in which a groove through which the contact head 210 of the battery 200 passes is provided in the inner groove wall of the mounting groove 11, the first conductive contact is accommodated in the hole, when the battery 200 is properly mounted, the contact head 210 is inserted into the groove to be abutted against the first conductive contact to establish an electrical connection, and when the battery 200 is reversely mounted, the end surface of the battery 200 is abutted against the inner wall of the mounting groove 11, and the contact piece 220 cannot extend into the groove to establish an electrical connection with the first conductive contact to prevent the battery 200 from being reversely mounted, also falls within the scope of protection of the invention.

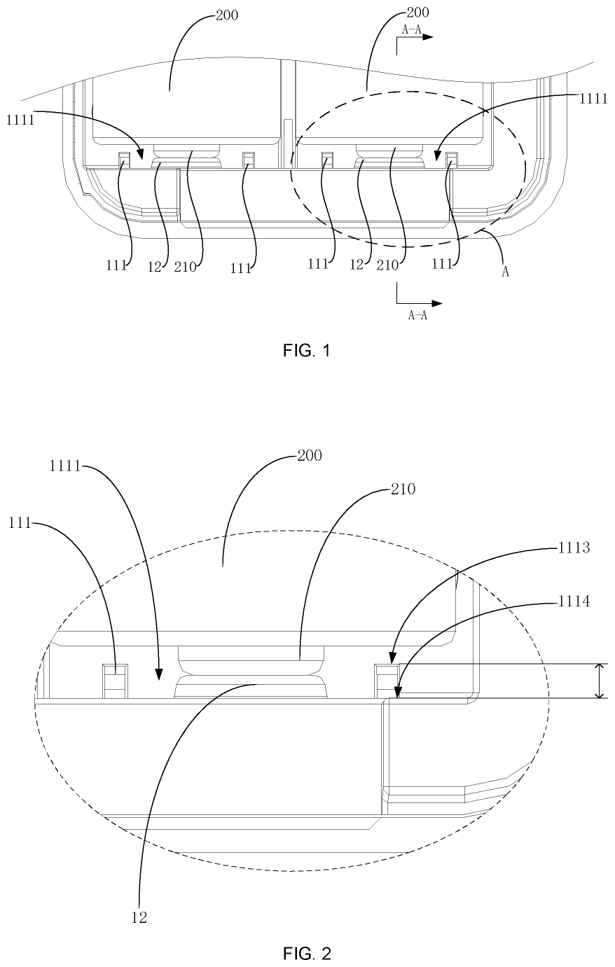

Specifically, as shown in FIG. 2 and FIG. 6, in the embodiment of the invention, the thickness of the two supporting members 111 gradually increases from the end adjacent to the notch of the mounting groove 11 to the end away from the notch of the mounting groove 11 so that the end of the two supporting members 111 adjacent to the notch of the mounting groove 11 forms a wedge-shaped guiding portion 1112. Herein, in the present embodiment, the distance value between the surface of the supporting member 111 connected to the mounting groove 11 and the end surface of the protruding tail end 1113 of the supporting member 111 is the thickness value H of the supporting member 111. The end of the supporting member 111 adjacent to the notch of the mounting groove 11 forms a wedge-shaped guiding portion 1112. In the process of mounting the battery 200, the outer surface of the wedge-shaped guiding portion 1112 of the battery 200 is broken, resulting in a phenomenon of an easy short circuit.

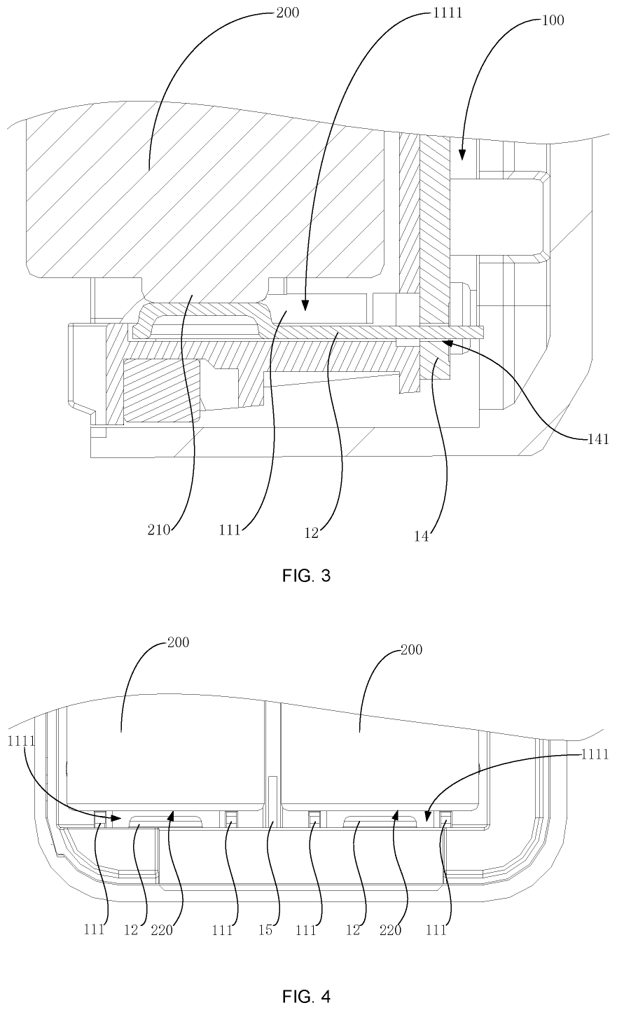

Specifically, as shown in FIG. 3, in the embodiment of the invention, the main body 10 is further provided with a circuit board 14, the circuit board 14 is provided with a socket 141 corresponding to the first conductive contact, one end of the first conductive contact is inserted into the socket 141 and is electrically connected to the circuit board 14, and the other end thereof is accommodated in the supporting space 1111. Herein, in the present embodiment, the first conductive contact is provided with a socket part, the socket part is inserted into the socket 141 provided in the circuit board 14, and the inner wall of the socket 141 is provided with a conductive sheet or a conductive coating so that the first conductive contact and the circuit board 14 are electrically connected and then are fixed by solder to enhance the conductive stability. The manner of electrically inserting the first conductive contact directly into the circuit board 14 to establish an electrical circuit effectively prevents an electrical connection using a conductive cable so that there are more disordered wirings inside the power supply 100 for an electronic cigarette. In addition, the first conductive contact directly establishes an electrical connection with the circuit board 14, the current is conducted stably, and a large current can be conducted, preventing the potential safety hazard that the conductive cable is prone to burning hot when the current is too large due to the connection using a conductive cable.

Further, as shown in FIG. 5, in the embodiment of the invention, the circuit board 14 is further electrically connected to a second conductive contact, the accommodating chamber is provided with an avoidance hole corresponding to the second conductive contact, one end of the second conductive contact is elastically mounted in the main body 10 and is electrically connected to the circuit board 14 and the other end thereof is accommodated in the mounting groove 11 through the avoidance hole and forms a mounting vacancy 131 in which the battery 200 is mounted with the first conductive contact, the second conductive contact is movable toward the inside of the main body 10 along the avoidance hole under the action of an external extrusion force, and the battery 200 is mounted in the mounting groove 11. Herein, in the present embodiment, the first conductive contact is a sheet-shaped positive electrode contact. The second conductive contact is a columnar negative electrode contact, and is abutted against the internal structure of the main body 10 by an elastic member so that the second conductive contact is movable along the avoidance hole. The elastic member can be made of an elastic silicone, an elastic plastic or a spring. In the present embodiment, the elastic member is a spring. The first conductive contact and the second conductive contact are oppositely provided in the mounting groove 11 at intervals and are both electrically connected to the circuit board 14. An elastic mounting vacancy 131 is formed therebetween so that when the battery 200 is mounted, one end of the negative contact piece 220 of the battery 200 is first inserted into the mounting chamber, is elastically abutted against the second conductive contact, and then squeezes the second conductive contact to partially press it into the body 10, so as to increase the volume of the mounting space. One end of the positive electrode contact head 210 of the battery 200 can be pressed into the mounting space to be abutted against the first conductive contact. When the battery 200 is disassembled, one end of the positive electrode contact head 210 of the battery 200 is pushed to squeeze the second conductive contact, and then the battery 200 is drawn from one end of the positive electrode to complete the disassembly. By forming an elastic mounting vacancy 131, in the process of mounting and disassembly, the outer wall of the battery 200 is suspended and operated to further prevent the phenomenon that the outer wall of the battery 200 is damaged and short-circuited.

Specifically, as shown in FIG. 5 or FIG. 6, in the embodiment of the invention, the mounting groove 11 is provided with at least two of the first conductive contacts and at least two of the second conductive contacts, at least two of the first conductive contacts and at least two of the second conductive contacts are correspondingly mounted in the mounting groove 11 and are provided side by side at intervals to form at least two mounting vacancies 131 provided side by side at intervals, and the intersection of each two mounting vacancies 131 is hollowed-out to form an avoidance space 112. Specifically, in the present embodiment, the mounting groove 11 is provided with at least two of the first conductive contacts and at least two of the second conductive contacts. At least two of the first conductive contacts and at least two of the second conductive contacts are spaced apart from each other at the same end of the mounting groove 11, and are electrically connected to the circuit board 14 through the circuit board 14, respectively. The two second conductive contacts are correspondingly provided at the other end of the mounting groove 11 so that the main body 10 only needs to reserve the space in which the elastic member is mounted at the same end of the mounting groove 11, so that the structure is more compact, thereby reducing the volume of the product. At the same time, the intersection of each mounting vacancy 131 is hollowed-out to form an avoidance space 112, which effectively prevents the wall thickness at the intersection of each mounting vacancy 131 from being thin and the wall thickness at other positions of the main body 10 from being uneven, resulting in a phenomenon of shrinkage and broking the surface in the process of processing and molding.

Further, as shown in FIG. 5 or FIG. 6, in the embodiment of the invention, each of the avoidance spaces 112 is provided with at least one separator 15, and at least one separator 15 is provided between the two conductive contacts provided adjacent to each other to separate the batteries 200 accommodated in the two adjacent mounting vacancies 131. Herein, in the present embodiment, each of the avoidance spaces 112 is provided with a separator 15, and the separator 15 is accommodated at the end of the avoidance space 112 adjacent to the first conductive contact, effectively separating the ends of the positive electrodes of two adjacent batteries 200 to further avoid the occurrence of a short circuit between the two batteries 200.

The invention further provides an electronic cigarette, which comprises an atomizing device and a power supply 100 for an electronic cigarette. Refer to the above embodiment for the specific structure of the power supply 100 for the electronic cigarette. Due to the use of all the technical solutions of all the above embodiments, the electronic cigarette has at least all the beneficial effects brought by the technical solutions of the above embodiments, which will not be described in detail herein.

The above are preferred embodiments of the invention merely and are not intended to limit the patent scope of the invention. Any equivalent structures made according to the description and the accompanying drawings of the invention without departing from the idea of the invention, or any equivalent structures applied in other relevant technical fields directly or indirectly are intended to be included in the patent protection scope of the invention.

What is claimed is:

1. A power supply for an electronic cigarette, comprising:
a main body (10), wherein the main body (10) comprises a mounting groove (11) for accommodating an external battery (200), one end of the mounting groove (11) is convexly provided with a first conductive contact (12) and at least one supporting member (111), and a height at which the at least one supporting member (111) protrudes is greater than a height at which the first conductive contact (12) protrudes; the battery (200) is provided with a contact head (210) protruding from the body of the battery (200), and when the battery (200) is properly mounted in the mounting groove (11), the contact head (210) is abutted against the first conductive contact (12) to establish an electrical connection; and when the battery (200) is reversely mounted in the mounting groove (11), the supporting member (111) is abutted against the body of the battery (200) so that the body of the battery (200) is spaced apart from the first conductive contact (12).

2. The power supply for an electronic cigarette according to claim 1, wherein there are two supporting members (111), the two supporting members (111) are symmetrically provided on both sides of the first conductive contact (12), a supporting space (1111) formed between opposite surfaces of the two supporting members (111), when the battery (200) is properly mounted in the mounting groove (11), the contact head (210) is inserted into the supporting space (1111) to be abutted against the first conductive contact (12), and when the battery (200) is reversely mounted in the mounting groove (11), the supporting member (111) is abutted against the body of the battery (200).

3. The power supply for an electronic cigarette according to claim 2, wherein a thickness of the two supporting members (111) gradually increases from the end adjacent to the notch of the mounting groove (11) to the end away from the notch of mounting groove (11), so that the end of the two supporting members (111) adjacent the notch of the mounting groove (11) forms a wedge-shaped guiding portion (1112).

4. The power supply for an electronic cigarette according to claim 1, wherein the main body (10) is further provided with a circuit board (14), the circuit board (14) is provided with a socket (141) corresponding to the first conductive contact (12), one end of the first conductive contact (12) is inserted into the socket (141) and is electrically connected to the circuit board (14), and the other end thereof is accommodated in the supporting space (1111).

5. The power supply for an electronic cigarette according to claim 4, wherein the circuit board (14) is further electrically connected to a second conductive contact (13), the accommodating chamber is provided with an avoidance hole corresponding to the second conductive contact (13), one end of the second conductive contact (13) is elastically mounted in the main body (10) and is electrically connected to the circuit board (14) and the other end thereof is accommodated in the mounting groove (11) through the avoidance hole and forms a mounting vacancy (131) in which the battery (200) is mounted with the first conductive contact (12), the second conductive contact (13) is movable toward the inside of the main body (10) along the avoidance hole under the action of an external extrusion force, and the battery (200) is mounted in the mounting groove (11).

6. The power supply for an electronic cigarette according to claim 5, wherein the mounting groove (11) is provided with at least two of the first conductive contacts (12) and at least two of the second conductive contacts (13), at least two of the first conductive contacts (12) and at least two of the second conductive contacts (13) are correspondingly mounted in the mounting groove (11) and are provided side by side at intervals to form at least two mounting vacancies (131) provided side by side at intervals, and the intersection of each two mounting vacancies (131) is hollowed-out to form an avoidance space (112).

7. The power supply for an electronic cigarette according to claim 6, wherein each of the avoidance spaces (112) is provided with at least one separator (15), and at least one separator (15) is provided between the two conductive contacts provided adjacent to each other to separate the batteries (200) accommodated in the two adjacent mounting vacancies (131).

8. An electronic cigarette, comprising the power supply (100) for an electronic cigarette according to claim 1.
